(19) United States
(12) Patent Application Publication
(10) Pub. No.: US 2024/0393845 A1
(43) Pub. Date: Nov. 28, 2024

(54) INFORMATION PROCESSING APPARATUS AND CONTROL METHOD

(71) Applicant: Lenovo (Singapore) Pte. Ltd., Singapore (SG)

(72) Inventors: Atsunobu Nakamura, Kanagawa (JP); Koudai Horinouchi, Kanagawa (JP); Kengo Sano, Kanagawa (JP)

(73) Assignee: Lenovo (Singapore) Pte. Ltd., Singapore (SG)

(21) Appl. No.: 18/613,760

(22) Filed: Mar. 22, 2024

(30) Foreign Application Priority Data
May 22, 2023 (JP) 2023-083951

(51) Int. Cl. G06F 1/20; G06F 1/3206

(52) U.S. Cl. CPC G06F 1/206; G06F 1/3206

(57) ABSTRACT

An information processing apparatus includes a computer system, a temperature sensor that detects a temperature, and a controller that controls an operation mode of the apparatus based on the temperature. The controller changes an operation mode of the computer system to a thermal protection mode in a case where the operation mode is a standard mode and the temperature exceeds a first reference temperature, changes the operation mode of the computer system to a dormant mode in a case where the operation mode is the thermal protection mode and the temperature exceeds a second reference temperature, and stops the operation of the apparatus in the case where the operation mode is the dormant mode and the temperature exceeds a third reference temperature. The thermal protection mode being an operation mode that consumes less power than the standard mode.

### CROSS-REFERENCE TO RELATED APPLICATIONS

This application claims priority to Japanese Patent Application No. 2023-083951 filed on May 22, 2023, the contents of which are hereby incorporated herein by reference in their entirety.

### BACKGROUND

### Technical Field

The present invention relates to an information processing apparatus and a control method, and relates to, for example, thermal protection that limits operation at high temperatures.

### Description of the Related Art

A processor is a core processing device of various information processing apparatuses including a personal computer (PC). Generally, the power consumption of a processor increases with increasing throughput. Power consumption is accompanied by heat generation, thus increasing the temperature of the processor itself or the temperatures of surrounding components. An excessive temperature rise may cause damage to an information processing apparatus itself or make it no longer possible for a user to carry the information processing apparatus. For this reason, an information processing apparatus may include a thermal protection mechanism. When a temperature is higher than a certain operating temperature range, the thermal protection mechanism suppresses the temperature rise by applying, to a system, an operation mode in which the throughput is suppressed to a lower than usual level.

For example, the heat generating device described in Japanese Unexamined Patent Application Publication No. 2007-233782 includes a processor having a changeable maximum power consumption value. The device periodically measures the power consumption value and the temperature value of the processor. When a value representative of a set of a plurality of measured power consumption values exceeds a predetermined threshold value, and when a temperature value exceeds a predetermined threshold value, the device detects that a state in which the amount of heat generated by the processor remains high has continued for a certain period of time, and reduces the maximum power consumption value of the processor.

According to a thermal protection function, a system may be shut down if a temperature further increases. However, a lowest drive frequency (LFM: Low Frequency Mode) is set for a processor. The LFM has the minimum value of clock frequency for performing the function. The processor does not operate unless the clock frequency is equal to or higher than the LFM, so that a certain amount or more of heat corresponding to the LFM is always generated to maintain the function. A processor having higher performance generates more heat, leading to a higher possibility that a thermal protection mechanism will cause the processor to stop working sooner. On the other hand, if the temperature does not lower to a predetermined operating temperature range after the processor comes to a complete halt, then the function of the system fails to recover. Further, a reboot and an instruction therefor are required to restore the function of the system.

Depending on a usage condition, a power saving mode that consumes less power than usual may be applied to the system. In the power saving mode, screen display and the processing related to screen display are stopped. When an operation mode for high temperatures is uniformly selected according to the thermal protection function, the screen display may be resumed according to the selected operation mode. The unexpected screen display may give the user a sense of discomfort.

### SUMMARY

An information processing apparatus according to one or more embodiments of the application includes: a computer system; a temperature sensor that detects a temperature; and a controller that controls an operation mode of the apparatus on the basis of the temperature, wherein the controller changes an operation mode of the computer system to a thermal protection mode in the case where the operation mode is a standard mode and the temperature exceeds a first reference temperature, changes the operation mode of the computer system to a dormant mode in the case where the operation mode is the thermal protection mode and the temperature exceeds a second reference temperature, and stops the operation of the apparatus in the case where the operation mode is the dormant mode and the temperature exceeds a third reference temperature, the thermal protection mode being an operation mode that consumes less power than the standard mode, the dormant mode being an operation mode that consumes less power than the thermal protection mode, and a higher temperature being set in the order of the first reference temperature, the second reference temperature, and the third reference temperature.

In the above-described information processing apparatus, the controller switches the operation mode between the standard mode and the low power consumption mode on the basis of the operating state of the computer system when the temperature is the first reference temperature or lower, and the controller changes the operation mode of the computer system to the dormant mode when the operation mode is the low power consumption mode and the temperature exceeds the first reference temperature. In the dormant mode and the low power consumption mode, the output of display information is limited. The low power consumption mode may be an operation mode that consumes less power than the standard mode and consumes more power than the dormant mode.

The above-described information processing apparatus may be provided with a heat dissipation unit that dissipates heat generated in the apparatus, wherein the controller may operate the heat dissipation unit more actively in the thermal protection mode than in the standard mode, and may stop the operation of the heat dissipation unit in the dormant mode.

The above-described information processing apparatus may be provided with a heat dissipation unit that dissipates heat generated in the apparatus, wherein the controller may stop the operation of the heat dissipation unit in the low power consumption mode and the dormant mode.

In the above-described information processing apparatus, the controller may change the operation mode to the standard mode in the case where the operation mode is the dormant mode, an activation instruction is detected, and the temperature is a fourth reference temperature or lower. The fourth reference temperature may be equal to or lower than the first reference temperature.

In the above-described information processing apparatus, the controller may change the operation mode to the thermal protection mode in the case where the operation mode is the dormant mode, an activation instruction is detected, and the temperature is a fifth reference temperature or lower. The fifth reference temperature may be higher than the first reference temperature and equal to or lower than the second reference temperature.

A control method according to one or more embodiments of the present application is a control method for an information processing apparatus including a computer system, a temperature sensor that detects a temperature; and a controller that controls an operation mode of the apparatus on the basis of the temperature, wherein the information processing apparatus may change an operation mode of the computer system to a thermal protection mode in the case where the operation mode is a standard mode and the temperature exceeds a first reference temperature, change the operation mode of the computer system to a dormant mode in the case where the operation mode is the thermal protection mode and the temperature exceeds a second reference temperature, and stop the operation of the apparatus in the case where the operation mode is the dormant mode and the temperature exceeds a third reference temperature, the thermal protection mode being an operation mode that consumes less power than the standard mode, the dormant mode being an operation mode that consumes less power than the thermal protection mode, and a higher temperature being set in the order of the first reference temperature, the second reference temperature, and the third reference temperature.

According to one or more embodiments of the present application, the usability of an information processing apparatus having a thermal protection function can be improved.

### BRIEF DESCRIPTION OF THE DRAWINGS

FIG. 1 is a schematic block diagram illustrating a hardware configuration example of an information processing apparatus according to one or more embodiments.

FIG. 2 is a schematic block diagram illustrating an example of the functional configuration of the information processing apparatus according to one or more embodiments.

FIG. 3 is a mode transition diagram illustrating an example of mode control according to one or more embodiments.

FIG. 4 is a table illustrating an example of a temperature control table according to one or more embodiments.

FIG. 5 is a table illustrating operation parameters according to one or more embodiments.

### DETAILED DESCRIPTION

Embodiments of the present application will be described with reference to the accompanying drawings.

First, the following is an overview of an information processing apparatus 1 according to one or more embodiments of the present application. The following description will focus mainly on the case where the information processing apparatus 1 is a PC. The information processing apparatus 1 is not necessarily limited to a PC, and may alternatively be configured as a smartphone, a tablet terminal device, or the like.

The information processing apparatus 1 controls its own operation mode on the basis of a temperature detected by a temperature sensor. The information processing apparatus 1 changes the operation mode to a thermal protection mode when the controlled operation mode is a standard mode and a detected temperature exceeds a first reference temperature. The thermal protection mode is an operation mode that consumes less power than the standard mode. The information processing apparatus 1 changes the operation mode to the dormant mode when the operation mode is the thermal protection mode and a detected temperature exceeds the second reference temperature. The dormant mode is an operation mode that consumes less power than the thermal protection mode. The second reference temperature is set to be higher than the first reference temperature. The information processing apparatus 1 stops the operation thereof when the operation mode is the dormant mode and a detected temperature exceeds a third reference temperature. The third reference temperature is set to be higher than the second reference temperature.

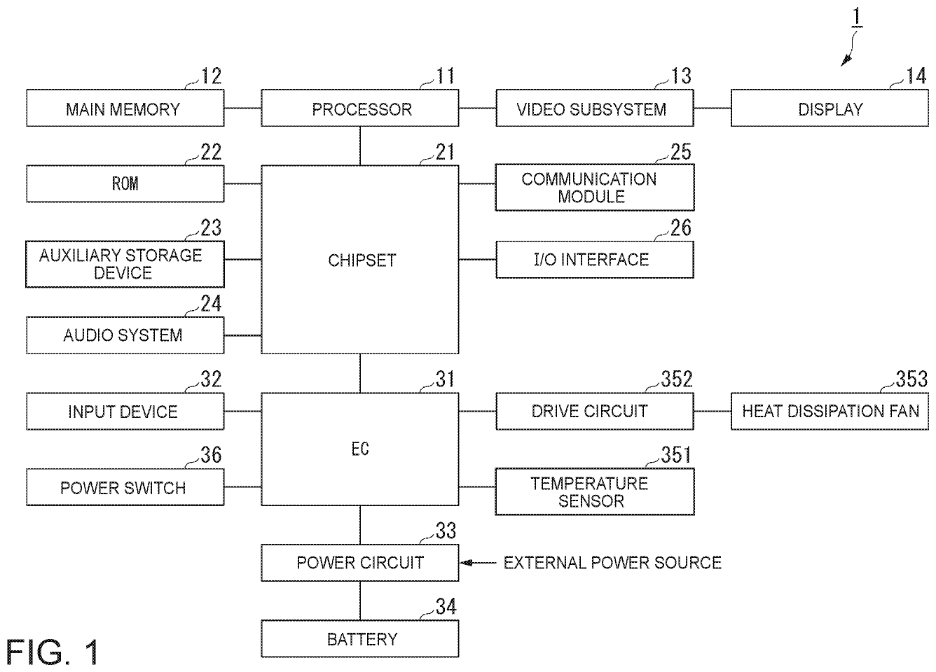

FIG. 1 is a schematic block diagram illustrating an example of the hardware configuration of the information processing apparatus 1 according to one or more embodiments. The information processing apparatus 1 includes a processor 11, a main memory 12, a video subsystem 13, a display 14, a chipset 21, a ROM 22, an auxiliary storage device 23, an audio system 24, a communication module 25, an I/O interface 26, an EC 31, an input device 32, a power circuit 33, a battery 34, a temperature sensor 351, a drive circuit 352, a heat dissipation fan 353, and a power switch 36.

The processor 11 is a core processing device that performs various types of arithmetic processing directed by instructions written in software (programs). The processing executed by the processor 11 includes reading and writing data from and to storage media such as the main memory 12 and the auxiliary storage device 23, inputting and outputting data to and from other devices, and the like. The processor 11 includes at least one CPU. The CPU controls the operation of the entire information processing apparatus 1. The CPU executes processing based on programs such as, for example, an OS (Operating System), firmware, device drivers, utilities, and application programs (which may be referred to as “apps” in the present application). Executing the processing directed by instructions (commands) written in various programs may be referred to as “executing a program” or “execution of a program” or the like.

The main memory 12 is a writable memory used as a reading area for an executable program of the processor 11 or as a work area for writing processing data of the executable program. The main memory 12 is composed of, for example, a plurality of DRAM (Dynamic Random Access Memory) chips. The processor 11 and the main memory 12 correspond to minimum hardware that constitutes a host system. The host system is a computer system that forms the core of the information processing apparatus 1.

The video subsystem 13 is a subsystem for implementing a function related to image display, and includes a video controller. The video controller processes drawing instructions from the processor 11, writes obtained drawing information into a video memory, and reads the drawing information from the video memory to output the read drawing information to the display 14 as the display data indicating display information (image processing). The video subsystem 13 may be configured by including a single or a plurality of GPUs (Graphic Processing Units) or coprocessors. A GPU is a processor that mainly performs real-time image processing and other parallel arithmetic processing. The GPU may share some processing with the CPU. The GPU may be integrated with the CPU that functions as the processor 11 and formed in the same core, or may be formed in a separate core from the CPU. The GPU may perform parallel arithmetic processing other than image processing and may also share some processing with the CPU.

The display 14 shows a display screen based on display data input from the video subsystem 13. The display 14 may be any one of, for example, an LCD (Liquid Crystal Display), an OLED (Organic Light Emitting Diode) display, and the like.

The chipset 21 has a plurality of controllers, and allows connection with a plurality of devices to receive various types of data. The controller is any one of or a combination of bus controllers such as, for example, a USB (Universal Serial Bus), a serial ATA (AT Attachment), an SPI (Serial Peripheral Interface) bus, a PCI (Peripheral Component Interconnect) bus, a PCI-Express bus, and an LPC (Low Pin Count). Devices to be connected include the ROM 22, the auxiliary storage device 23, the audio system 24, the communication module 25, the I/O interface 26, and the EC 31.

The ROM (Read Only Memory) 22 mainly stores system firmware, firmware for controlling the operations of the EC 31 and other devices, and the like. The ROM 22 may be any one of, for example, an EEPROM (Electrically Erasable Programmable Read Only Memory), a flash ROM, and the like.

The auxiliary storage device 23 stores various types of data used for processing by the processor 11 or other devices or various types of data acquired by such processing, and various programs. The auxiliary storage device 23 may be any one of or a combination of, for example, an SSD (Solid State Drive), an HDD (Hard Disk Drive), and the like.

The audio system 24 has a microphone and a speaker (not illustrated) connected thereto so as to record, reproduce and output audio data. The microphone and the speaker may be included in the information processing apparatus 1, or may be separate from the information processing apparatus 1.

The communication module 25 connects to a communication network wirelessly or by wire. The communication module 25 communicates various types of data with other devices connected to the communication network. The communication module 25 includes, for example, a wireless LAN (Local Area Network), and enables transmission and reception of various types of data between devices according to a predetermined wireless communication method (e.g., IEEE802.11). In a wireless LAN, communication between devices is performed via access points.

The I/O interface 26 is connected with various devices such as peripheral devices by wire or wirelessly. The I/O interface 26 is a connector for inputting and outputting data by wire according to, for example, USB standards.

The EC (Embedded Controller) 31 is a one-chip microcomputer that monitors and controls various devices (peripheral devices, sensors, and the like) regardless of the operating state of the system of the information processing apparatus 1. The EC 31 has a CPU, a ROM, a RAM, multiple channel A/D (Analog-to-Digital) input terminals, D/A (Digital-to-Analog) output terminals, timers, and digital I/O terminals (not illustrated) separately from the processor 11. Connected to the I/O terminals of the EC 31 are, for example, the input device 32, the power circuit 33, the temperature sensor 351, the drive circuit 352, the power switch 36, and the like.

The input device 32 detects an operation by a user, and outputs an operation signal based on the detected operation to the EC 31. The input device 32 includes any combination of, for example, a keyboard, a touchpad, and the like. The input device 32 may be a touch sensor, or may overlap the display 14 and be configured as a touch panel.

The power circuit 33 converts the voltage of DC power supplied from an external power source or the battery 34 into a voltage required for the operation of each device that constitutes the information processing apparatus 1, and supplies the power having the converted voltage to a supply destination device. The power circuit 33 executes power supply according to the control of the EC 31. The power circuit 33 includes a converter that converts the voltage of the power supplied thereto, and a power feeder that charges the battery 34 with the power of the converted voltage. The power feeder charges the battery 34 with the power left unconsumed in each device from the power supplied by an external power source. If no power is supplied from an external power source, or if the power supplied from the external power source is insufficient, then the power discharged from the battery 34 is supplied to each device as operating power.

The battery 34 charges or discharges power by using the power circuit 33. The battery 34 may be any one of, for example, a lithium-ion battery, a sodium-ion battery, and the like.

The temperature sensor 351, the drive circuit 352, and the heat dissipation fan 353 constitute a heat dissipation unit that dissipates the heat generated in the apparatus.

The temperature sensor 351 detects the temperature of the unit, and outputs a temperature signal indicating the detected temperature to the EC 31. The temperature sensor 351 is installed adjacent to, for example, the processor 11 so as to detect the temperature of the processor 11.

The drive circuit 352 supplies the power supplied thereto from the power circuit 33 to the heat dissipation fan 353 according to the control of the EC 31. Thus, the operation of the heat dissipation fan 353 is controlled. The heat dissipation fan 353 dissipates the heat generated in the information processing apparatus 1. The heat dissipation fan 353 includes a motor, which consumes the power supplied from the drive circuit 352 to rotate fins (blades), and causes air to flow into the chassis of the information processing apparatus 1. The inflowing air exchanges heat with each section of the information processing apparatus 1, and then is discharged out of the chassis.

The power switch 36 controls the state of power supply to the entire information processing apparatus 1 to either power ON or power OFF each time a press operation is accepted. When the press operation is accepted, the power switch 36 outputs a press signal indicating the press to the EC 31. When the information processing apparatus 1 is powered off and a press signal is input from the power switch 36, the EC 31 causes the power circuit 33 to start supplying power to each device of the information processing apparatus 1 (power on). When the processor 11 detects the start of power supply thereto, the processor 11 reads the system firmware from the ROM 22, loads the read system firmware into the main memory 12, and executes activation processing (booting) according to instructions written in the system firmware. In the activation processing, the processor 11 loads data saved in the auxiliary storage device 23 into the main memory 12. Thereafter, the processor 11 boots an OS, and after the booting of the OS is completed, the processor 11 starts execution of device drivers for controlling devices such as the auxiliary storage device 23, the communication module 25, and the I/O interface 26.

Meanwhile, when power is supplied to the information processing apparatus 1 and the press signal is received from the power switch 36, the EC 31 causes the processor 11 to execute a stop processing (shutdown). In the stop processing, the processor 11 saves the data existing in the work area at that time to the auxiliary storage device 23. After finishing the saving of data, the processor 11 stops processing performed by applications, device drivers, and other programs that are being executed at that time. Thereafter, the processor 11 notifies the EC 31 of the completion of the stop processing. The EC 31 causes the power circuit 33 to stop the supply of power to each device of the information processing apparatus 1.

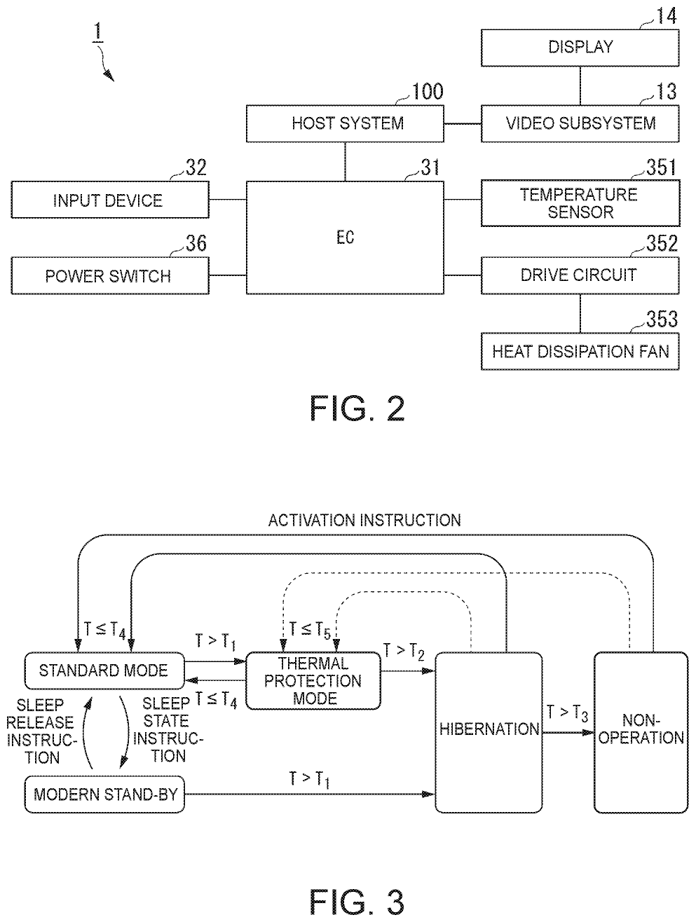

A description will now be given of an example of the functional configuration of the information processing apparatus 1 according to one or more embodiments. FIG. 2 is a schematic block diagram illustrating an example of the functional configuration of the information processing apparatus 1 according to one or more embodiments.

The information processing apparatus 1 includes a host system 100.

The function of the host system 100 is implemented by executing various programs by the processor 11 and through collaboration with hardware such as the main memory 12, the chipset 21, the communication module 25, the I/O interface 26, and the EC 31.

The host system 100 is a computer system that executes an OS, manages execution of other programs such as applications, manages calculation resources such as memories and processes, and manages input/output to and from each device. The host system 100 operates according to an operation mode determined by itself. The host system 100 refers to the power control parameter sets stored in a register of the processor 11 in advance to identify the power control parameters related to the operation mode. The host system 100 controls power consumption by using the identified power control parameters. Further, the EC 31 refers to drive parameter sets stored in advance in the ROM thereof so as to identify the drive parameters related to the operation mode. The EC 31 uses the identified drive parameters to cause the drive circuit 352 to drive the heat dissipation fan 353. Operation mode examples will be described later.

The host system 100 controls the operation mode of the apparatus on the basis of the temperature indicated by a temperature signal input from the temperature sensor 351. The operation modes that can be selected by the information processing apparatus 1 include the standard mode, a modern stand-by, the thermal protection mode, and the hibernation. An example of the mode control according to one or more embodiments will now be described. FIG. 3 is a mode transition diagram illustrating an example of the mode control according to one or more embodiments. The example of FIG. 3 illustrates pairs of operation modes before and after changing among the standard mode, the modern stand-by, the thermal protection mode, the hibernation, and non-operation, and the transition condition for each pair.

The non-operation is a state in which the host system 100 is not operating. The standard mode and the thermal protection mode are set as the operation modes after a change starting from the non-operation. The standard mode is an operation mode in which expected functions based on the specifications of the information processing apparatus 1 are provided. The standard mode is provided when the temperature at a particular time is within a predetermined standard operating temperature range. The thermal protection mode is an operation mode that consumes less power than the standard mode. In the thermal protection mode, the operation of the heat dissipation fan 353 may be more active than that in the standard mode. In other words, the thermal protection mode is an operation mode in which the amount of heat generation is less and the amount of heat dissipation is more than that in the standard mode. The thermal protection mode is applied in a temperature range that is higher than the standard operating temperature range.

Any transition from the non-operation to the standard mode or the thermal protection mode is conditional on the detection of an activation instruction. The activation instruction is given, for example, when the power switch 36 is pressed. When the host system 100 is not operating, and the pressing of the power switch 36 is detected, the EC 31 starts the activation processing of the host system 100. More specifically, the EC 31 detects the contact of the contact point of the power switch 36, and starts supply of power from the power circuit 33 to the processor 11, the main memory 12, and the ROM 22. The processor 11 reads the system firmware from the ROM 22, and runs the read system firmware by using the main memory 12 as the work area so as to detect a device to be connected thereto. After that, the processor 11 starts executing the OS to start the function as the host system 100.

If a temperature T notified from the temperature sensor 351 is T₄ or lower, then the EC 31 notifies the standard mode to the processor 11 so as to cause the processor 11 to operate according to the standard mode. T₄ corresponds to a predetermined temperature threshold value related to changing from the thermal protection mode to the standard mode. The processor 11 refers to, for example, power control parameter sets stored in advance in a register to identify the power control parameter corresponding to the standard mode. The processor 11 controls the power consumption according to the identified power control parameter. Further, the EC 31 drives the heat dissipation fan 353 according to the standard mode. The EC 31 refers to, for example, the drive parameter sets stored in advance in the ROM to identify the drive parameter corresponding to the standard mode.

In the standard mode, the heat dissipation fan 353 does not necessarily need to be operated. For the standard mode, an operation start temperature Tₛₜₐᵣₜ and an operation stop temperature Tₛₜₒₚ may be further set for the drive parameters. Tₛₜₐᵣₜ may be any temperature that is lower than T₁ (which will be described later). Tₛₜₒₚ may be any temperature that is lower than Tₛₜₐᵣₜ. When the temperature T notified from the temperature sensor 351 rises to Tₛₜₐᵣₜ or higher, the EC 31 causes the drive circuit 352 to start supplying power based on the identified drive parameter to the heat dissipation fan 353. When the temperature T notified from the temperature sensor 351 lowers to Tₛₜₒₚ or lower, the EC 31 causes the drive circuit 352 to stop supplying power to the heat dissipation fan 353.

If the temperature T notified from the temperature sensor 351 is higher than T₄ and equal to or lower than T₅, then the EC 31 notifies the thermal protection mode to the processor 11 and causes the processor 11 to operate according to the thermal protection mode. T₅ corresponds to the upper limit of temperature that allows the change to the thermal protection mode. The processor 11 refers to, for example, the power control parameter set stored in advance in the register to identify the power control parameter corresponding to the thermal protection mode. The processor 11 controls power consumption according to the identified power control parameter. In addition, the EC 31 drives the heat dissipation fan 353 according to the thermal protection mode. The EC 31 refers to, for example, the drive parameter set stored in advance in the ROM to identify the drive parameter corresponding to the thermal protection mode. The EC 31 causes the drive circuit 352 to supply power to the heat dissipation fan 353 on the basis of the identified drive parameter.

If the temperature T notified from the temperature sensor 351 is higher than T₅ or lower than a standard operation temperature range, then the EC 31 does not have to activate the processor 11. In such a case, even when pressing of the power switch 36 is detected, the EC 31 does not have to cause the power circuit 33 to start supply of power to the processor 11.

The thermal protection mode and the modern stand-by are set as the operation modes after the change from the standard mode.

When the current operation mode is the standard mode, the EC 31 monitors the temperature T notified from the temperature sensor 351. If the temperature T exceeds T₁, the EC 31 notifies the processor 11 of the thermal protection mode and causes the processor 11 to operate in the thermal protection mode. Further, the EC 31 drives the heat dissipation fan 353 according to the thermal protection mode.

When the current operation mode is the standard mode, the host system 100 waits for a sleep state instruction. The sleep state instruction is an event such as an operation or input for instructing a sleep state. An event predetermined in the OS may be used as the sleep state instruction. For example, pressing a power button, selecting a sleep menu, idling out, or the like can be applied as the sleep state instruction. The idling out refers to continuance of a state in which no operation is detected while waiting for an operation for a certain period of time or more. If the information processing apparatus 1 is a laptop PC, a state in which the two continuously connected chassis are closed may be applied as the sleep state instruction. When the sleep state instruction is detected, the host system 100 changes the operation mode to the modern stand-by.

The modern stand-by is one type of the sleep state. In other words, the modern stand-by is a system state in which power consumption is less than that in the standard mode and some functions are restricted. The modern stand-by is an extended state of an S0 state specified by ACPI (Advanced Configuration and Power Interface), and is a system state that provides lower power consumption than the standard mode. The modern stand-by corresponds to the stand-by mode, and is a state in which input and output to and from some devices or functions are stopped.

More specifically, in the modern stand-by, the function of the display 14 is stopped, and the output of display data indicative of various display information is limited. Further, in the modern stand-by, the operation of the heat dissipation fan 353 may be stopped. The host system 100 may accept the input of operation signals from the input device 32, inputs and outputs via the I/O interface 26, transmission and reception using the communication module 25, the input of audio signals from the audio system 24, and the like (connected stand-by). The standard mode corresponds to the S0 state among the system states specified by ACPI.

When changing the operation mode to the modern stand-by, the processor 11 refers to, for example, the power control parameter set stored in advance in the register to identify the power control parameter corresponding to the modern stand-by. The processor 11 controls power consumption according to the identified power control parameter. Further, the host system 100 notifies the EC 31 of the modern stand-by as the new operation mode, and causes the EC 31 to stop the operation of the heat dissipation fan 353. The EC 31 causes, for example, the drive circuit 352 to stop the supply of power from the power circuit 33 to the heat dissipation fan 353.

The standard mode and the hibernation are set as the operation modes after the change from the modern stand-by.

The host system 100 waits for a sleep release instruction when the current operation mode is the modern stand-by. The sleep release instruction is an event such as an operation, an input or the like for instructing the release of the sleep state. As the sleep state release instruction, an event predetermined in the OS may be used.

For example, pressing the power button, inputting an operation signal from the input device 32, inputting an audio signal from the audio system 24, or wired connection to or disconnection from another device can be applied as the sleep state release instruction. If the information processing apparatus 1 is a laptop PC, then a state in which two connected chassis are open may be applied as the sleep state release instruction. The laptop PC has a structure in which two chassis are engaged with each other at one side of each thereof, and one chassis can rotate relative to the other chassis around an axis parallel to those sides. The laptop PC has a magnetic sensor in one chassis, and can detect the open and closed states of the other chassis having a permanent magnet. The open and closed states of the two chassis are detected on the basis of the magnetic force detected by the magnetic sensor. The magnetic sensor outputs the detected magnetic signal to the host system 100 via the EC 31. Thus, the host system 100 is notified of the open or closed state of the two chassis.

When the sleep state release instruction is detected, the host system 100 changes the operation mode to the standard mode. When changing the operation mode to the standard mode, the processor 11 refers to, for example, the power control parameter set stored in advance in the register to identify the power control parameter corresponding to the standard mode. The processor 11 controls the power consumption according to the identified power control parameter. Further, the host system 100 notifies the EC 31 of the standard mode as the operation mode, and causes the EC 31 to operate the heat dissipation fan 353 in the standard mode. The EC 31 refers to, for example, the drive parameter set stored in advance in the ROM to identify the drive parameter corresponding to the standard mode. The EC 31 causes the drive circuit 352 to supply power to the heat dissipation fan 353 according to the identified drive parameter.

When the current operation mode is the modern stand-by, the host system 100 monitors the temperature T notified from the temperature sensor 351 via the EC 31. When the temperature T exceeds T₁, the host system 100 changes the operation mode to the hibernation. When changing the operation mode to the hibernation, the host system 100 stops running a program being executed. The host system 100 generates an image file containing various types of intermediate data generated by processing that is being executed, parameters, and the like, and stores (saves) the generated image file in the auxiliary storage device 23. Thereafter, the processor 11 constituting the host system 100 ends the operation. Then, the EC 31 causes the drive circuit 352 to stop supplying power to the processor 11. Furthermore, the EC 31 causes the drive circuit 352 to stop supplying power to the heat dissipation fan 353.

The standard mode and the hibernation are set as the operation modes after the change from the thermal protection mode. When the current operation mode is the thermal protection mode, the host system 100 monitors the temperature T notified from the temperature sensor 351 via the EC 31. When the temperature T exceeds T₂, the host system 100 changes the operation mode to the hibernation. T₂ corresponds to the upper limit of the temperature that allows an operation in the thermal protection mode. T₂ may be a temperature equal to or higher than T₅. When changing the operation mode to the hibernation, the host system 100 stops the execution of a program that is being executed.

As with the case of changing to the hibernation from the modern stand-by, the host system 100 generates an image file and stores (saves) the generated image file in the auxiliary storage device 23 when changing to the hibernation from the thermal protection mode. Thereafter, the processor 11 constituting the host system 100 ends the operation. Then, the EC 31 causes the power circuit 33 to stop supplying power to the processor 11 and the main memory 12. In addition, the EC 31 causes the drive circuit 352 to stop supplying power to the heat dissipation fan 353.

The hibernation corresponds to an S4 state among the system states specified by ACPI. The hibernation is a dormant state in which the processor 11 and the main memory 12 are stopped.

When the temperature T is T₄ or lower, the host system 100 changes the operation mode to the standard mode. At this time, the processor 11 changes the operation mode to the standard mode. The processor 11 controls power consumption according to the identified power control parameter. Further, the host system 100 notifies the EC 31 of the standard mode and causes the EC 31 to operate the heat dissipation fan 353 in the standard mode.

The standard mode, the thermal protection mode, and the non-operation are set as the operation modes after the change from the hibernation. As with the case with the transition from the non-operation to the standard mode or the thermal protection mode, the transition from the hibernation to the standard mode or the thermal protection mode is conditional on the detection of the activation instruction. The EC 31 electrically or mechanically detects the contact of the contact point of the power switch 36, and starts supplying power from the power circuit 33 to the processor 11, the main memory 12, and the auxiliary storage device 23. The processor 11 reads an image file from the auxiliary storage device 23 and stores the read image file in the main memory 12. Thereafter, the processor 11 uses the read image file to resume the execution of the program that was being executed immediately before changing the operation mode to the hibernation.

If the temperature T notified from the temperature sensor 351 is T₄ or lower, then the EC 31 causes the processor 11 to operate according to the standard mode. The EC 31 notifies the processor 11 of the standard mode as the operation mode, and causes the processor 11 to operate in the standard mode. Further, the EC 31 causes the drive circuit 352 to drive the heat dissipation fan 353 according to the standard mode.

If the temperature T notified from the temperature sensor 351 is higher than T₄ and equal to or lower than T₅, then the EC 31 operates the processor 11 according to the thermal protection mode to cause the drive circuit 352 to drive the heat dissipation fan 353, as described above.

If the temperature T notified from the temperature sensor 351 is higher than T₅ or lower than the standard operating temperature range, then the EC 31 does not have to activate the processor 11.

When the current operation mode is the thermal protection mode, the EC 31 monitors the temperature T notified from the temperature sensor 351. When the temperature T exceeds T₃, the EC 31 sets the information processing apparatus 1 to non-operation (shutdown). At this stage, the supply of power to the processor 11 and the main memory 12 has already been stopped. The EC 31 causes the power circuit 33 to stop the supply of power to the auxiliary storage device 23, the drive circuit 352, and other devices.

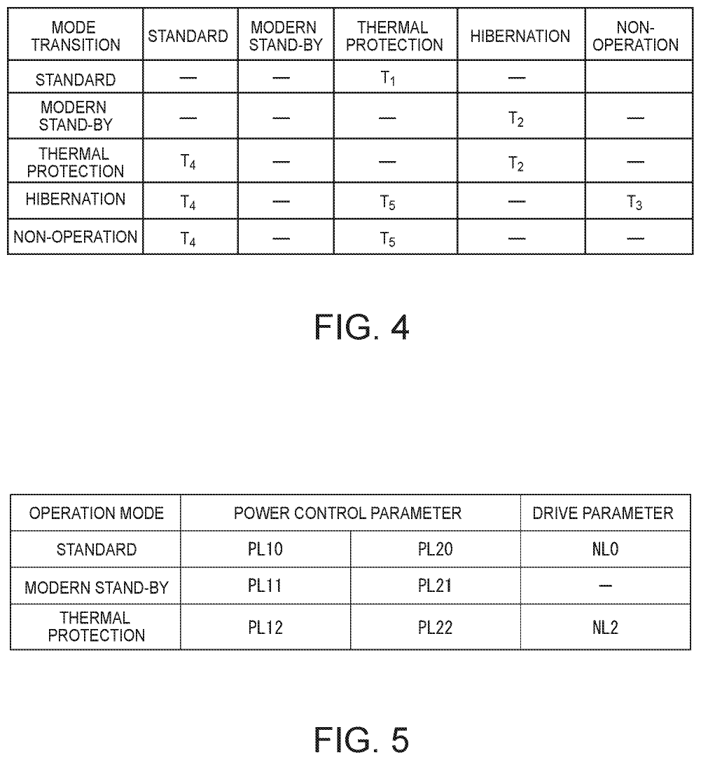

FIG. 4 illustrates an example of a temperature control table according to one or more embodiments. The temperature control table is stored in advance in, for example, the ROM included in the EC 31. The temperature control table is a data table indicating the temperature threshold value for each mode transition. The EC 31 refers to the temperature control table to compare the temperature parameter corresponding to the mode transition from the current operation mode to an operation mode after a change with the temperature T notified from the temperature sensor 351, and determines whether a transition condition is satisfied.

Each row of the first column of FIG. 4 indicates the operation mode before a change, and each column of the first row indicates the operation mode after the change. The mode transition from the standard mode to the thermal protection mode and the mode transition from the modern stand-by to the hibernation are associated with T₁. The mode transition from the thermal protection mode to the hibernation is associated with T₂. A temperature that is higher than T₁ is set as T₂. The mode transition from the hibernation to the non-operation is associated with T₃. A temperature that is higher than T₂ is set as T₃.

The mode transition from the thermal protection mode to the standard mode, the mode transition from the hibernation to the standard mode, and the mode transition from the non-operation to the standard mode are associated with T₄. A temperature equal to T₁ or lower than T₁ is set as T₄.

The mode transition from the hibernation to the thermal protection mode and the mode transition from the non-operation to the thermal protection mode are associated with T₅. A temperature equal to T₂ or lower than T₂ is set as T₅.

A description will now be given of examples of operation parameters according to one or more embodiments. FIG. 5 illustrates the operation parameters according to one or more embodiments. The operation parameters include the power control parameters and the drive parameters. The power control parameters are set for each of the standard mode, the modern stand-by, and the thermal protection mode. The power control parameters for each of the modern stand-by and the thermal protection mode correspond to power consumption that is less than the power control parameters for the standard mode.

In the illustrated example, a first power limit (PL1: Power Limit 1) and a second power limit (PL2: Power Limit 2) are set for each operation mode. PL1 corresponds to rated power. The rated power is a threshold value for allowing the moving average of power consumption to temporarily exceed this value, but for restricting the moving average thereof from exceeding this value on a steady basis (e.g., continuously over several seconds to several tens of seconds or more). The window length in the moving average (observation period related to the moving average of power consumption) is typically, for example, approximately 1 to 10 seconds. PL2 is a threshold value for restricting power consumption from exceeding this value even temporarily. In general, the higher the clock frequency, the more arithmetic processing the processor 11 performs, and the power consumption increases accordingly. The processor 11 has a control mechanism that adjusts the clock frequency such that the instantaneous value of power consumption does not exceed PL2 and the moving average of power consumption does not exceed PL1.

In the example of FIG. 5, PL10, PL11, and PL12 are rated powers for the standard mode, the modern stand-by, and the thermal protection mode, respectively. PL10 is equal to or larger than PL11, and equal to or larger than PL12. However, PL11 may be set to be equal to PL12, smaller than PL12, or larger than PL12. PL2 corresponds to maximum power. The maximum power is a threshold value for restricting the moving average value of power consumption from temporarily exceeding this value. The maximum power corresponds to the upper limit of the power consumption of the processor. In the example of FIG. 5, PL20, PL21, and PL22 denote the maximum powers for the standard mode, the modern stand-by, and the thermal protection mode, respectively. PL20 is equal to or larger than PL21, and equal to or larger than PL22. However, PL21 can be equal to PL22, smaller than PL22, or larger than PL22.

The drive parameters are set for the standard mode and the thermal protection mode. In the example of FIG. 5, NL0 and NL2 denote noise levels of the heat dissipation fan 353 corresponding to the standard mode and the thermal protection mode, respectively. NL2 is equal to or higher than NL0. Defining the amount of operation of the heat dissipation fan 353 is not limited to the noise level, and may also use the rotational speed of a motor, power consumption, or the like. The noise level of the heat dissipation fan 353 is not set for the modern stand-by. The modern stand-by is one type of the sleep state. For the modern stand-by, the heat dissipation fan 353 does not operate and remains still.

The case where the EC 31 controls the operation mode of the information processing apparatus 1 on the basis of a temperature indicated by a temperature signal input from the temperature sensor 351 has been mainly described above as an example; however, the present invention is not limited thereto. In the information processing apparatus 1, a controller separate from the EC 31 may control the operation mode of the information processing apparatus 1. The separate controller may be the chipset 21. The processing for some mode transitions may be shared between the EC 31 or the separate controller and the host system 100. For example, if the operation mode at the present moment is the hibernation or the non-operation, the EC 31 or the separate controller performs the processing for the transition to the standard mode, the modern stand-by, or the thermal protection mode. On the other hand, the host system 100 performs the processing for the transition among the standard mode, the modern stand-by, and the thermal protection mode, and the transition from the standard mode, the modern stand-by, or the thermal protection mode to the hibernation or the non-operation.

The above description has mainly focused on the case where the activation instruction for the transition from the non-operation to the standard mode or the thermal protection mode is executed when a press on the power switch 36 is detected; however, the present invention is not limited thereto. The EC 31 may wait for an activation instruction from another device by wire or wirelessly, and may start the activation processing of the host system 100 when the activation instruction is detected. The activation instruction may be transmitted via a communication network.

As described above, the information processing apparatus 1 according to one or more embodiments includes a computer system (e.g., the host system 100), the temperature sensor 351 that detects temperatures, and a controller (e.g., EC 31) that controls the operation mode of the apparatus on the basis of a detected temperature. If the operation mode is the standard mode and a detected temperature exceeds a first reference temperature (e.g., T₁), the controller changes the operation mode of the computer system to the thermal protection mode. If the operation mode is the thermal protection mode and a detected temperature exceeds a second reference temperature (e.g., T₂), the controller changes the operation mode of the computer system to the dormant mode. If the operation mode is the dormant mode (e.g., hibernation) and a detected temperature exceeds a third reference temperature (e.g., T₃), the controller stops the operation of the apparatus (i.e., non-operation). The thermal protection mode is an operation mode that consumes less power than the standard mode, and the dormant mode is an operation mode that consumes less power than the thermal protection mode. A higher temperature is set in the order of the first reference temperature, the second reference temperature, and the third reference temperature.

According to the configuration, when a detected temperature exceeds the second reference temperature, the operation mode of the computer system is changed from the thermal protection mode to the dormant mode, and when a detected temperature exceeds the third reference temperature, the computer system stops. By changing to dormant mode before the computer system completely shuts down, power consumption is stopped. The shutdown of the computer system caused by a further temperature rise is avoided, thus making it possible to restore the operation of the computer system without performing the activation processing when the temperature falls into an operating temperature range.

Further, the controller may switch the operation mode between the standard mode and a low power consumption mode on the basis of the operating state (e.g., a sleep state instruction and a sleep release instruction) of the computer system, or may change the operation mode of the computer system to the dormant mode when the operation mode is a low power consumption mode (e.g., the modern stand-by) and a detected temperature exceeds the first reference temperature. In a low power consumption mode, the output of display information (e.g., display data) is limited. The low power consumption mode is an operation mode that consumes less power than the standard mode, while consuming more power than the dormant mode. According to the configuration, depending on the operating state of the computer system, the operation mode is changed to the dormant mode rather than the thermal protection mode when the operation mode is the low power consumption mode, and the temperature exceeds the first reference temperature. When functional limitation is expected due to a temperature rise, avoiding a change to the thermal protection mode that involves output of display information makes it possible to avoid giving the user a sense of discomfort due to the presentation of display information. In addition, changing to the dormant mode prevents a temperature rise due to power consumption, thus making it possible to restore the operation of the computer system without performing the activation processing when the temperature drops into the standard operating temperature range.

Further, the information processing apparatus 1 may include a heat dissipation unit (e.g., the heat dissipation fan 353) that dissipates the heat generated in the apparatus. In the thermal protection mode, the controller may operate the heat dissipation unit more actively than in the standard mode, and may stop the operation of the heat dissipation unit in the dormant mode.

According to the configuration, heat is dissipated more actively in the thermal protection mode than in the standard mode, thus suppressing a temperature rise. Heat is not dissipated in the dormant mode. In the dormant mode, power is not consumed, so that stopping the operation of the heat dissipation unit is allowed. Therefore, power can be saved by not operating the heat dissipation unit.

Further, the information processing apparatus 1 may include a heat dissipation unit (e.g., the heat dissipation fan 353) that dissipates the heat generated in the apparatus. The controller may stop the operation of the heat dissipation unit in the low power consumption mode and the dormant mode.

According to the configuration, the heat dissipation unit is not operated in the low power consumption mode and the dormant mode. Changing the operation mode from the low power consumption mode to the dormant mode maintains the state in which the operation of the heat dissipation unit remains stopped. This makes it possible to avoid giving the user a sense s of discomfort due to activating the heat dissipation unit by changing from the low power consumption mode to the thermal protection mode.

Further, the controller may change the operation mode to the standard mode when the operation mode is the dormant mode, an activation instruction (e.g., a press on the power switch 36) is detected, and a detected temperature is equal to or lower than a fourth reference temperature (e.g., T₄). Here, the fourth reference temperature is equal to or lower than the first reference temperature.

According to the configuration, the information processing apparatus 1 operates in the standard mode when the activation instruction is detected, and a detected temperature has dropped to the first reference temperature or lower due to the change from the standard mode to the thermal protection mode. When the temperature drops to the first reference temperature or lower, the information processing apparatus 1 can start the operation in the standard mode of the computer system without performing the activation processing when the power switch 36 is pressed.

Further, the controller may change the operation mode to the thermal protection mode when the operation mode is the dormant mode, the activation instruction (e.g., a press on the power switch 36) is detected, and a detected temperature is a fifth reference temperature (e.g., T₅) or lower. Here, the fifth reference temperature is higher than the first reference temperature, and equal to or lower than the second reference temperature.

According to the configuration, the information processing apparatus 1 operates in the thermal protection mode when the activation instruction is detected, and a detected temperature is higher than the first reference temperature or lower involved in the change from the standard mode to the thermal protection mode and drops to the second reference temperature or lower involved in the change from the thermal protection mode to the dormant mode. Even if the temperature does not drop to the first reference temperature or lower, when the temperature drops to the second reference temperature or lower, the information processing apparatus 1 can start the operation of the computer system in the thermal protection mode, in which less heat is generated than in the standard mode, without performing the activation processing when the power switch 36 is pressed. By suppressing a temperature rise, the convenience from the operation can be restored while reducing the possibility of changing back to the dormant mode again.

Although the embodiments have been described above in detail with reference to the accompanying drawings, the specific configuration is not limited to the above-described embodiments, and includes designs and the like within the scope that does not depart from the gist of the present invention. The configurations described in the above embodiments can be arbitrarily combined as long as there is no contradiction, and some configurations may be omitted.

For example, the information processing apparatus 1 may omit the drive circuit 352 and the heat dissipation fan 353. In such a case, the processing for setting the drive parameters described above is omitted. Further, the information processing apparatus 1 may include a refrigerant circulation circuit in place of the drive circuit 352 and the heat dissipation fan 353, or in addition to the drive circuit 352 and the heat dissipation fan 353. In such a case, in place of the operation amount of the heat dissipation fan 353, or in addition to the operation amount of the heat dissipation fan 353, the circulation amount of the refrigerant circulation circuit may be controlled according to the same relationship as that between the power consumption of the host system 100 and the operation amount of the heat dissipation fan 353. Further, the power control parameters for the standard mode or the thermal protection mode include at least the first power limit, and may omit the second power limit. The power control parameters for the standard mode or the thermal protection mode may further include a fourth power limit. The fourth power limit is a threshold value for instantaneously limiting even greater power consumption.

### DESCRIPTION OF SYMBOLS

1 information processing apparatus
11 processor
12 main memory
13 video subsystem
14 display
21 chipset
22 ROM
23 auxiliary storage device
24 audio system
25 communication module
26 I/O interface
31 EC
32 input device
33 power circuit
34 battery
351 temperature sensor
352 drive circuit
353 heat dissipation fan
36 power switch
100 host system

1. An information processing apparatus comprising:
a computer system;
a temperature sensor that detects a temperature; and
a controller that controls an operation mode of the apparatus based on the temperature,
wherein the controller
changes an operation mode of the computer system to a thermal protection mode in a case where the operation mode is a standard mode and the temperature exceeds a first reference temperature,
changes the operation mode of the computer system to a dormant mode in a case where the operation mode is the thermal protection mode and the temperature exceeds a second reference temperature, and
stops the operation of the apparatus in a case where the operation mode is the dormant mode and the temperature exceeds a third reference temperature,
the thermal protection mode being an operation mode that consumes less power than the standard mode,
the dormant mode being an operation mode that consumes less power than the thermal protection mode, and
a higher temperature being set in order of the first reference temperature, the second reference temperature, and the third reference temperature.

2. The information processing apparatus according to claim 1,
wherein the controller
switches the operation mode between the standard mode and a low power consumption mode on the basis of an operating state of the computer system in the case where the temperature is the first reference temperature or lower, and
changes the operation mode of the computer system to the dormant mode in the case where the operation mode is the low power consumption mode and the temperature exceeds the first reference temperature,
output of display information being limited in the dormant mode and the low power consumption mode, and
the low power consumption mode being an operation mode that consumes less power than the standard mode and consumes more power than the dormant mode.

3. The information processing apparatus according to claim 1, including a heat dissipation unit that dissipates heat generated in the apparatus,
wherein the controller operates the heat dissipation unit more actively in the thermal protection mode than in the standard mode, and
stops an operation of the heat dissipation unit in the dormant mode.

4. The information processing apparatus according to claim 2, including a heat dissipation unit that dissipates heat generated in the apparatus,
wherein the controller stops an operation of the heat dissipation unit in the low power consumption mode and the dormant mode.

5. The information processing apparatus according to claim 1,
wherein the controller changes the operation mode to the standard mode
in the case where the operation mode is a dormant mode, an activation instruction is detected, and the temperature is a fourth reference temperature or lower,
the fourth reference temperature being equal to or lower than the first reference temperature.

6. The information processing apparatus according to claim 5,
wherein the controller changes the operation mode to the thermal protection mode
in the case where the operation mode is a dormant mode, an activation instruction is detected, and the temperature is equal to or lower than a fifth reference temperature,
the fifth reference temperature being higher than the first reference temperature, and equal to or lower than the second reference temperature.

7. A control method for an information processing apparatus including:
a computer system;
a temperature sensor that detects a temperature; and
a controller that controls an operation mode of the apparatus based on the temperature,
wherein the information processing apparatus
changes an operation mode of the computer system to a thermal protection mode in a case where the operation mode is a standard mode and the temperature exceeds a first reference temperature,
changes the operation mode of the computer system to a dormant mode in a case where the operation mode is the thermal protection mode and the temperature exceeds a second reference temperature, and
stops an operation of the apparatus in a case where the operation mode is the dormant mode and the temperature exceeds a third reference temperature,
the thermal protection mode being an operation mode that consumes less power than the standard mode,
the dormant mode being an operation mode that consumes less power than the thermal protection mode, and
a higher temperature being set in the order of the first reference temperature, the second reference temperature, and the third reference temperature.
